(19) United States
(12) Patent Application Publication
(10) Pub. No.: US 2016/0078169 A1
(43) Pub. Date: Mar. 17, 2016

(54) METHOD OF AND APPARATUS FOR PROVIDING INFORMATION ON A GENOMIC SEQUENCE BASED PERSONAL MARKER

(71) Applicant: SK TELECOM CO., LTD., Seoul (KR)

(72) Inventors: Jung Hyun NAMKUNG, Seoul (KR); Tae Gyun YUN, Yongin-si Gyeonggi-do (KR); Sung Gon YI, Yongin-si (KR); Byung Chul LEE, Guri-si (KR)

(21) Appl. No.: 14/817,067

(22) Filed: Aug. 3, 2015

Related U.S. Application Data
(63) Continuation of application No. PCT/KR2014/000823, filed on Jan. 28, 2014.

(30) Foreign Application Priority Data
Feb. 1, 2013 (KR) 10-2013-0011803
Jan. 21, 2014 (KR) 10-2014-0007344

(51) Int. Cl. G06F 19/22; G06F 19/00

(52) U.S. Cl. CPC G06F 19/22; G06F 19/3431

(57) ABSTRACT

The present disclosure provides a method for providing information about a gene sequence-based personal marker. The method includes: obtaining base sequence-related information from a target sample; performing a quality control of a base sequence corresponding to the base sequence-related information obtained from the target sample; comparing the base sequence, for which the quality control is performed, with a reference sequence; extracting a personal identification genetic variation marker from a result of the sequence comparison; evaluating optimality of the extracted personal identification genetic variation marker; and outputting a sequence corresponding to a personal identification genetic variation marker having the evaluated optimality which is higher than a predetermined level.

### CROSS-REFERENCE TO RELATED APPLICATION

The present application is a continuation of International Patent Application No. PCT/KR2014/000823, filed Jan. 28, 2014, which is based upon and claims the benefit of priority to Korean Patent Application Nos. 10-2013-0011803, filed on Feb. 1, 2013, and 10-2014-0007344, filed on Jan. 21, 2014. The disclosure of the above-listed applications are hereby incorporated by reference herein in their entirety.

### SEQUENCE LISTING

The instant application contains a Sequence Listing which has been submitted electronically in ASCII format and is hereby incorporated by reference in its entirety. Said ASCII copy, created on Oct. 30, 2015, is named 4900-0118_SL.txt and is 35,193 bytes in size.

### TECHNICAL FIELD

The present disclosure in one or more embodiments relates to a method of providing information about a gene sequence-based personal marker and an apparatus therefor.

### BACKGROUND ART

The statements in this section merely provide background information related to the present disclosure and do not necessarily constitute prior art.

Since human genome projects have been completed, human DNA base sequences have been decoded and various functions of human genes have been found therefrom. In particular, various genetic variations have been discovered, and it has been found that they not only cause a difference in human traits, but also that they can act as a cause of certain diseases. Accordingly, human genome analysis studies have been accelerated more and more. However, there have been difficulties in determining which of the vast number of genetic variations that can occur in humans genomes can be an etiology.

As the next generation sequencing (NGS) technologies develop, it has become possible to decode base sequences of the whole genome of individual human beings. Through the comparison and analysis of base sequences and variants of a disease group and a normal group, it became possible to extract disease-specific gene variations. In addition, a method for the generation of unique molecular markers in existing breeding material by selecting a marker associated with a trait, identifying the existing variation at the nucleotide level within a set of markers within a germplasm and introducing a selectable marker by the introduction of one or more nucleotides at positions in a constant region of the marker by targeted nucleotide exchange has been employed (see, Korean Patent Application Laid-open No. 10-2011-0094268).

However, the inventor(s) has noted that the method described above in some situations only provides highly specific genetic variation information, and thus is not able to provide reliable and useful information.

### SUMMARY

In some embodiments of the present disclosure, a method for providing information about a gene sequence-based personal marker includes: obtaining base sequence-related information from a target sample; performing a quality control of a base sequence corresponding to the base sequence-related information obtained from the target sample; comparing the base sequence, for which the quality control is performed, with a reference sequence; extracting a personal identification genetic variation marker from a result of the sequence comparison; evaluating optimality of the extracted personal identification genetic variation marker; and outputting a sequence corresponding to a personal identification genetic variation marker having the evaluated optimality which is higher than a predetermined level.

In some embodiments of the present disclosure, an apparatus for providing information about gene sequence-based personal marker includes: an input part configured to input base sequence-related information obtained from a target sample; a quality control operation part configured to perform a quality control of a base sequence corresponding to the obtained base sequence-related information; a comparison operation part configured to compare the base sequence, for which the quality control is performed, with a reference sequence; a genetic variation extraction part configured to extract a personal identification genetic variation marker from the sequence comparison result; a sutability operation part configured to evaluate optimality of the extracted personal identification genetic variation marker; and an output part configured to output a evaluation result of the personal identification genetic variation marker optimality.

### DESCRIPTION OF DRAWINGS

FIG. 1 is a flowchart of a method for providing information about the gene sequence-based personal marker, in accordance with some embodiments of the present disclosure.

FIG. 2 is a schematic block diagram of an apparatus for providing information about the gene sequence-based personal marker, in accordance with some embodiments of the present disclosure.

FIG. 3 is a schematic block diagram of a quality control operation part, in accordance with some embodiments of the present disclosure.

FIG. 4 is a schematic block diagram of a comparison operation part, in accordance with some embodiments of the present disclosure.

FIGS. 5-8 are exemplary sequences produced through simulations which are subjected to reliability calculations listed in Tables 1 and 2. FIG. 5 discloses SEQ ID NOS 5-39, respectively, in order of appearance. FIG. 6 discloses SEQ ID NOS 40-72, respectively, in order of appearance. FIG. 7 discloses SEQ ID NOS 73-107, respectively, in order of appearance. FIG. 8 discloses SEQ ID NOS 108-146, respectively, in order of appearance.

FIGS. 9-12 are calculation results for each of said sequences of FIGS. 5-8.

FIG. 13 includes flowcharts for calculating utility scores of three genetic variations, on the basis of an association with biological traits of gene markers, in accordance with some embodiments of the present disclosure.

### DETAILED DESCRIPTION

Hereinafter, embodiments of the present disclosure are described in detail with reference to the accompanying drawings. Advantages and features of the present disclosure and methods of accomplishing the same will become apparent with reference to embodiments to be described in detail in conjunction with the attached drawings. However, the present disclosure is not intended to be limited to the embodiments set forth below, but is intended to be embodied in many different forms. The embodiments of the disclosure are only provided to fully convey the concept of the disclosure to those of ordinary skill in the field to which the disclosure pertains, and the present disclosure is only defined by the appended claims. The same reference numerals throughout the specification refer to the same elements.

In the present disclosure, the term “reliability evaluation” refers to evaluating the probable significance of selected markers. Examples “reliability evaluation” include, but are not limited to, evaluating the genetic variation analysis results using information about the number of the supporting reads, the number of base sequences and the quality of the sequences which are used in extracting a genetic variation marker.

In the present disclosure, the term “easiness evaluation” refers to evaluating the ease of detection of the experimental marker. Examples “easiness evaluation” include, but are not limited to, analyzing and evaluating the occurrence of repeated sequences, the characteristics of sequence composition such as GC base content, and the occurrence of additional individual variations around the genetic variations.

In the present disclosure, the term “usefulness evaluation” refers to evaluating the usefulness based on the association with biological traits of markers. Examples “usefulness evaluation” include, but are not limited to, evaluating the usefulness based on the association with biological traits of gene markers such as association with the risk of diseases and association with targeted anticancer agents.

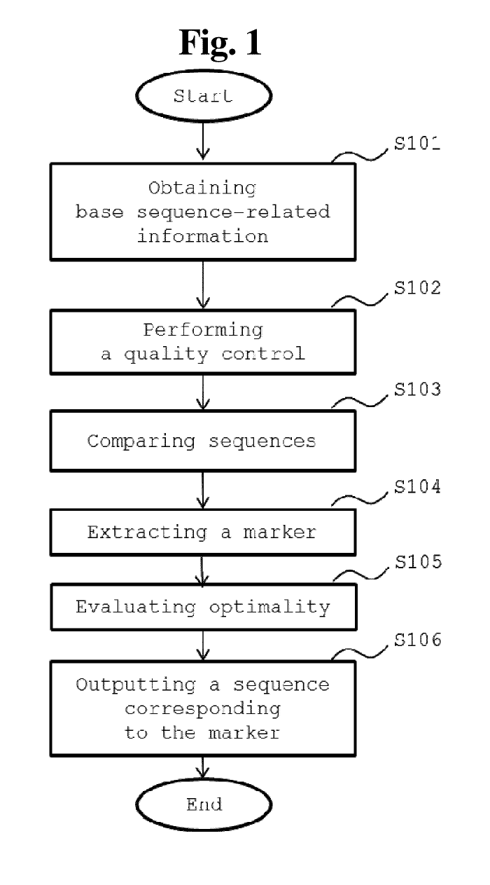

FIG. 1 is a flowchart of a method for providing information about the gene sequence-based personal marker, in accordance with some embodiments of the present disclosure.

In some embodiments, at S101, base sequence-related information is obtained from a target sample. At S102, a quality control of a base sequence corresponding to the base sequence-related information obtained from the target sample is performed. At S103, the base sequence, for which the quality control is performed, is compared with a reference sequence. At S104, a personal identification genetic variation marker is extracted from a result of the sequence comparison. As S105, optimality of the extracted personal identification genetic variation marker is evaluated. At S106, a sequence corresponding to a personal identification genetic variation marker having the evaluated optimality which is higher than a predetermined level, is outputted.

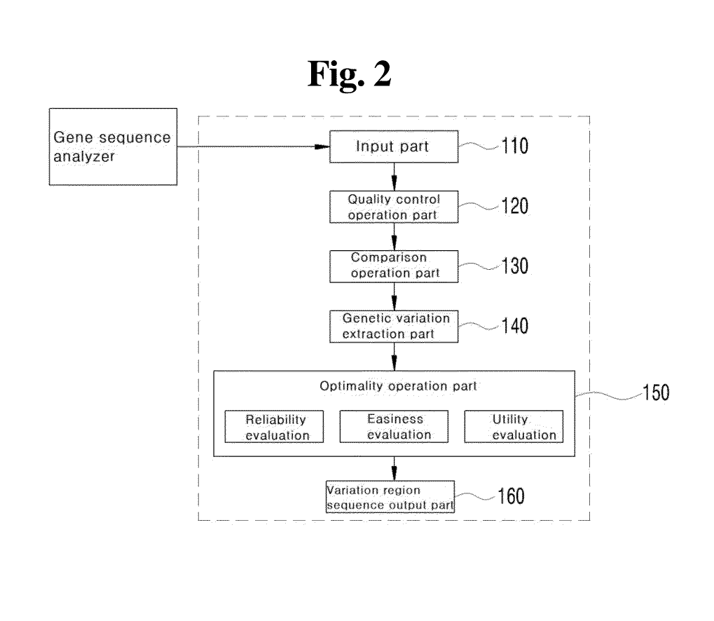

FIG. 2 is a schematic block diagram of an apparatus for providing information about the gene sequence-based personal marker, in accordance with some embodiments of the present disclosure.

The apparatus for providing information about gene sequence-based personal marker includes: an input part 110 configured to input base sequence-related information obtained from a target sample; a quality control operation part 120 configured to perform a quality control of a base sequence corresponding to the obtained base sequence-related information; a comparison operation part 130 configured to compare the base sequence, for which the quality control is performed, with a reference sequence; a genetic variation extraction part 140 configured to extract a personal identification genetic variation marker from the sequence comparison result; a suitability operation part 150 configured to evaluate optimality of the extracted personal identification genetic variation marker; and an output part 160 configured to output an evaluation result of the personal identification genetic variation marker optimality. In some embodiments, one or more of the parts 120-150 is/are implemented by, or include(s), one or more processors and/or application-specific integrated circuits (ASICs) specified for respectively corresponding operations and functions described herein in the present disclosure. In some embodiments, the methods according to at least one embodiment of the present disclosure are implemented as computer-readable code on a non-transitory computer-readable recording medium. The non-transitory computer-readable recording medium includes any data storage device configured to store data readable and/or executable by a computer system. Examples of the non-transitory computer-readable recording medium include, but are not limited to, magnetic storage media (e.g., magnetic tapes, floppy disks, hard disks, etc.), optical recording media (e.g., a compact disk read only memory (CD-ROM) and a digital video disk (DVD)), magneto-optical media (e.g., a floptical disk), and hardware devices that are specially configured to store and execute program instructions, such as a ROM, a random access memory (RAM), a flash memory, etc. In some embodiments, data, such as various sequences or personal markers described herein, are stored on a non-transitory computer-readable recording medium.

In some embodiments, in order to select the marker with high utility as the personal identification marker among the personal genetic variation markers, the reliability evaluation, the easiness evaluation and the utility evaluation are performed. The genetic information extracted from the results of the evaluation presents a peripheral sequence including the base sequence of the genetic variations into a standard sequence file format such as fasta format.

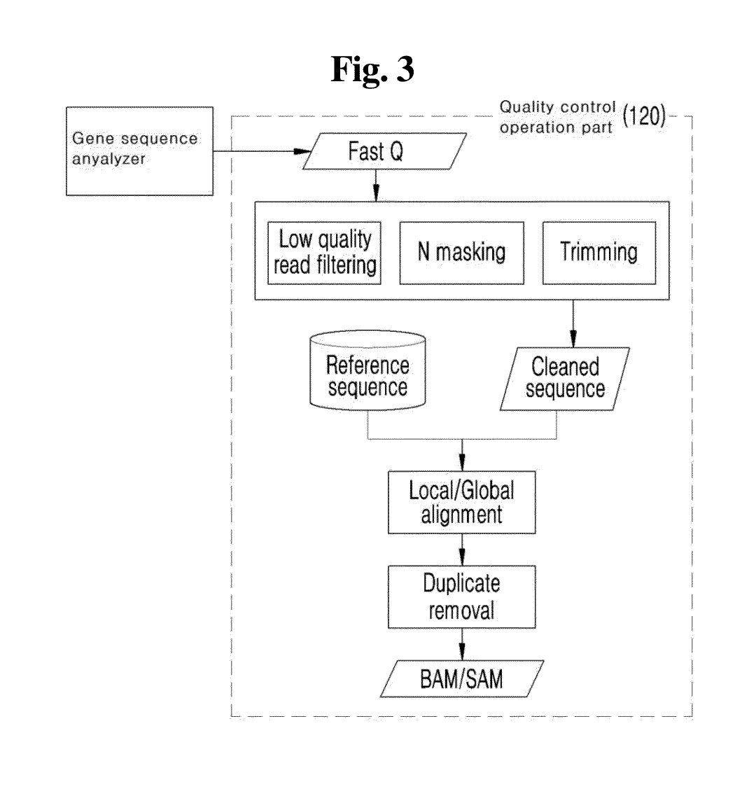

FIG. 3 is a schematic block diagram of a quality control operation part, in accordance with some embodiments of the present disclosure. The trimming, N-masking and low quality read filtering are performed based on the quality score for each position of genes. The cleaned sequence is compared with the reference sequence by a global alignment or a local alignment. The arrangement is performed using program such as BWA, BWASW, Bowtie2 to prepare an output file in SAM or BAM format.

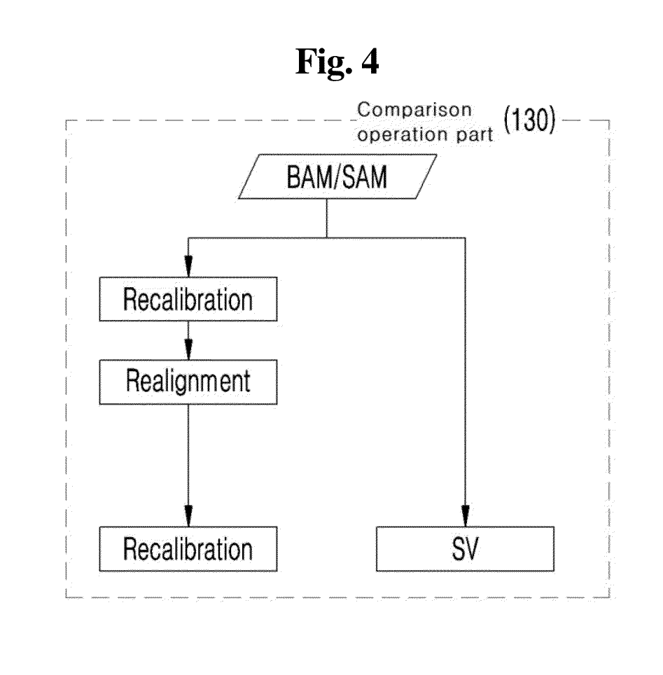

FIG. 4 is a schematic block diagram of a comparison operation part, in accordance with some embodiments of the present disclosure.

The process of extracting the genetic variation marker, such as a single-nucleotide polymorphism (SNP) or a structural variation (SV), uses a read file that has undergone the above-mentioned quality control process. The extraction of SNP and short INDEL variation marker is analyzed using GATK UnifiedGenotyper and SAMtools mpileup. In order to improve the accuracy of the extracted marker, the processes of realignment and recalibration is undergone. The extraction of SV can be done with programs such as BreakDancer and Pindel in order to discover Inter/intrachromosomal rearrangement, large INDEL, inversion, long range repeat sequence variation and large structural variation.

In some embodiments of the present disclosure, the evaluation of the marker is divided into i) the reliability evaluation, ii) the easiness evaluation, and iii) the utility evaluation. In the reliability evaluation, the genetic variation results are evaluated using information such as the number of the supporting reads and the quality of sequences used in the extraction of genetic variation. In the easiness evaluation, the occurrence of repeated sequences, the sequence composition properties such as GC content, the occurrence of personal genetic variation around the corresponding genetic variation are analyzed to evaluate the ease of the experiment. In the utility evaluation, the utility is evaluated based on the association with gene markers of biological traits such as the association with the degree of risk of diseases and the association with anticancer agents.

In some embodiments of the present disclosure, the “reliability evaluation” is a process to evaluate the reliability of the genetic variation, and assign scores based on the number of the supporting reads and the quality of the sequences, discordant read pair and clipped read used in the extraction of the genetic variation, and then evaluate the break point for each variation. This is calculated in accordance with the equation as follows:

R=f(Σᵢⱼ(wᵢ(Rᵢⱼ)),

wherein, f( ) is a link function; wi( ) is a weighting function; and Rᵢⱼ is a score that takes into account the mapping quality of the supporting leads each type, and the quality of the individual sequences.

In some embodiments of the present disclosure, the reliability of SNP is defined by a geometric mean (Qi) of a mapping quality (Qᵢ^{M}) and a base quality (Qᵢ^{B}), a quality-based variation ratio (Mₛ), a quality (Aₛ) of reads (supporting reads) containing the variation, a multiplication of the depth of the corresponding location and the overall average depth ratio (Dₛ).

There are a total n of supporting reads in the position of the found SNP (i=1, . . . , n), and we assume the reads with the reference nucleotide sequence of n-m. At this time, the base quality (Qᵢ^{B}) and the mapping quality (Qᵢ^{M}) denotes a base quality and a mapping quality of the i-th read, and is calculated as follows.

$${Q}_{i}^{B} = \{ \begin{matrix}{{c}_{B}}^{( {q}_{i}^{B} - {\overline{q}}^{B} ) / {s}^{B}} , & {q}_{i}^{B} > {q}_{m}^{B} \\ 0 , & otherwise\end{matrix} , {Q}_{i}^{M} = \{ \begin{matrix}{{c}_{M}}^{( {q}_{i}^{M} - {\overline{q}}^{M} ) / {s}^{M}} , & {q}_{i}^{M} > {q}_{m}^{M} \\ 0 , & otherwise\end{matrix}$$

wherein, qₘ^{B} and qₘ^{M} are the minimum base quality and the mapping quality value to be satisfied, respectively, and represent the average base quality of the entire sequences and the mapping quality value of the associated samples, respectively. C_{B} and C_{M} use \sqrt{2} as a scale constant in the following examples. Qi, i.e., the quality value of the i-th read, is defined by a multiplication of the base quality of the read and the mapping quality as follows.

Qᵢ=Qᵢ^{B}Qᵢ^{M}

The quality-based variation ratio (Mₛ), the quality of the support reads (Aₛ), and the depth ratio of the corresponding position (Dₛ) are defined, respectively, as follows.

Mₛ=Σᵢ₌₁ⁿQᵢ/Σᵢ₌₁^{m}Qᵢ,

Aₛ=Σᵢ₌₁ⁿQᵢ,

Dₛ=m/d

wherein, d is the average depth of the entire sequence of the sample.

The reliability of the SNP is shown below.

Q^{SNP}=AₛMₛDₛ

Table 1 below shows the reliability calculation example of the two SNP created by simulation.

TABLE 1

| | | | | Score of | |
|---|---|---|---|---|---|
| | Supporting | Total | Score of | supporting | |
| | reads | read | read | read | Reliability |
| SNP1 | 15 | 30 | 31.81 | 14.30 | 0.86 |
| SNP2 | 2 | 30 | 31.81 | 1.13 | 0.04 |

In some embodiments of the present disclosure, the reliability (Q^{sv}) of the structural variation (SV) is defined as the multiplication of a mapping quality (Qᵢ^{M}) with a base quality (Qᵢ^{M}).

Q^{sv}=Q^{M}Σᵢ₌₁ⁿQᵢ^{B}

For the calculation of the reliability of the structural variation, there are a total n of supporting reads (atypical read and cutting read) in the found structural variation region (that is, in the case of paired-end read with the center of the cutting surface, a region corresponding to the insert size; and in the case of single-end read, a region corresponding to two times the length of the read), assuming a read with the reference sequence of m-n. Also, Qᵢ^{M} is an average of the remaining reads, excluding the supporting reads. Qᵢ^{B} is defined as the mapping quality value as follows.

$${Q}_{i}^{B} = \{ \begin{matrix}{c}_{B}^{( {\overline{q}}_{i}^{B} - {\overline{q}}^{B} ) / {s}^{B}} , & {\overline{q}}_{i}^{B} > {q}_{m}^{B} \\ 0 , & otherwise\end{matrix} , {\overline{q}}_{i}^{B} = {\sum }_{j = 1}^{l} {q}_{ij}^{B} / l ,$$

wherein l is the length of read

$${Q}^{M} = \{ \begin{matrix}{c}_{M}^{( {\overline{q}}^{NM} - {\overline{q}}^{M} ) / {s}^{M}} , & {\overline{q}}^{NM} > {q}_{m}^{M} \\ 0 , & otherwise\end{matrix} ,$$

wherein Q̅^{NM} is an average mapping quality value of the mapped sequence and a reference sequence and is defined as follows:

q̅^{NM}=Σᵢ₌ₙ₊₁^{m}qᵢ^{M}/(m−n).

wherein C_{B} and C_{M} use \sqrt{2} as a scale constant in the following example.

Table 2 below shows a calculated example of the reliability for the structural variation of two inserts generated through a simulation.

TABLE 2

| | Supporting | Normal | | Average | |
|---|---|---|---|---|---|
| | (atypical) | mapped | Mapping | read | Score of |
| | read | read | quality | quality | reliability |
| SV1 | 8 | 78 | 60 | 18.85 | 8.67 |
| SV2 | 4 | 82 | 39.08 | 19.1 | 1.42 |

In some embodiments of the present disclosure, the “easiness evaluation” is a scale for determining the ease of identification of marker extracted by a method such as Polymerase Chain Reaction (PCR) or the target sequence analysis, and is calculated in accordance with the following formula:

A=ΣwᵢAᵢ

wherein Aᵢ is an itemized easiness, and wᵢ is a weight of each easiness.

In order to calculate the itemized easiness, the regional polymorphisms include, for example, SNP and short INDEL, but are not limited thereto. If there is a reference sequence and the other substituents or short INDELs in the marker of interest and the surrounding sequence, the easiness thereto is determined. For example, it is calculated as follows.

Aᵣₚ={1 in the case of homo SNP; 0 in the case of homo indel; −1 in the case of the hetero SNP; and −9 in the case of hetero indel}

In addition, the sequence complexity is introduced in order to evaluate the self-assembly or the uniqueness, and it is calculated as follows:

A_{SP}=CΣf(sᵢ)

wherein the word length is l, f(s) is a function of the sequence phase frequency, and C is a constant.

In addition, “GC content” indicates the melting point for use of primers such as PCR. Therefore, the GC content which is necessary to be introduced to the function is calculated as follows:

A_{OC}=C₁p(GC)+C₂p(AT)+C₃

wherein, Cₙ is a coefficient, and XY in p(XY) is the content.

In some embodiments of the present disclosure, if the upstream and downstream surrounding sequences of the found translocation genetic variation cutting surface have the sequences below, the easiness is calculated as follows.

BP_upstream:
(SEQ ID NO: 1)
GACGCCCCAGGCCGCGGTGGAGTTGCGCGCGGCTTC[A]AAAGTGGAGTG
GAGCAGGCCTGC
BP_downstream:
(SEQ ID NO: 2)
AGCACAGGCAGGCACCAGCTGGGCAGTGT[A/T]AGGATGCTGGAGCAGC
ATCCGT[-]ACCCCAC

In other words, the above-mentioned upstream surrounding sequence has one of the homo SNP and so there is no deduction in Aᵣₚ. On the other hand, in the case of the downstream, there are a hetero SNP and a homo indel and so one point is deducted. In the case of Aₛₚ, it is calculated in a manner similar to that disclosed in papers (Computers & Chemistry23 (3-4): 263-201). The use that it is for determining the number capable of producing primer or the like, but is not limited thereto. A_{qc} is to calculate appropriate weight (the maximum value at 0.5) on the GC content, for example, using the Shannon entropy. The easiness is calculated from the sum of these weights. For example, if all the weights on the factors considered herein is set to ⅓, the results are shown in Table 3 below.

TABLE 3

| Surrounding | | | | | A |
|---|---|---|---|---|---|
| sequence | Aᵣₚ | Aₛₚ | A_{qc} | As | (=min (As)) |
| Upstream | 60/60 | 0.356 | 0.88 | 0.412 | 0.412 |
| downstream | 59/60 | 0.407 | 0.95 | 0.452 | |

In some embodiments of the present disclosure, the flanking sequence of the found deletion genetic variation cutting surface is as shown below,

BP_upstream:
(SEQ ID NO: 3)
GGGCGCGGGCGCGCGGGGCGGCGGTGAGGGCGGCTGGCGGGGCCGGGGGC
GCCGGGGGGG
BP_downstream:
(SEQ ID NO: 4)
CCACTGGGGAGAGGCTGTTCTGACTCTGCAGGTGGGACAGGGACAGATGG
CCACCAGGGT

The result of applying the calculation method of the easiness is shown in Table 4 below.

TABLE 4

| Surrounding | | | | | A |
|---|---|---|---|---|---|
| sequence | Aᵣₚ | Aₛₚ | A_{qc} | As | (=min (As)) |
| Upstream | 60/60 | 0.056 | 0.29 | 0.115 | 0.115 |
| downstream | 60/60 | 0.328 | 0.95 | 0.426 | |

Since the easiness score A in Table 4 is smaller as compared with that in Table 3, the easiness is determined to be decreased.

In some embodiments of the present disclosure, the “utility evaluation” is to evaluate the utility based on the association with biological traits of genetic marker such as the degree of risk of diseases, relevance and association with targeted anticancer agents. For example. the utility is calculated in accordance with the following formula:

U=ΣwᵢUᵢ,

wherein Uᵢ is an itemized utility, and wᵢ is a weight of each utility.

Each utility is calculated by identifying whether a function of the region is appropriate for the user's purpose with respect to the functional group in the area corresponding to the genetic marker. For example, if any of the coding region, the regulatory region and the intergenic region corresponds to the region of interest, each of c1, c2, c3 (U_{f}=c1>c2>c3) is given. In this case, if the target anticancer agents are associated with the genetic marker, the utility is calculated by evaluating the response to drugs. The genetic marker associated with the target anticancer agents is used when determining the treatment methods. For example, it is calculated as follows:

Uₘ=f (whether there is a region including the target anticancer agent-related variation, 1 or 0)

Moreover, if the genetic marker is associated with the disease, the degree of risk of diseases is evaluated and then the utility is calculated. For example, it is calculated by the equation as follows:

Uᵢ=f (whether region including the risk factors of diseases, 1 or 0)

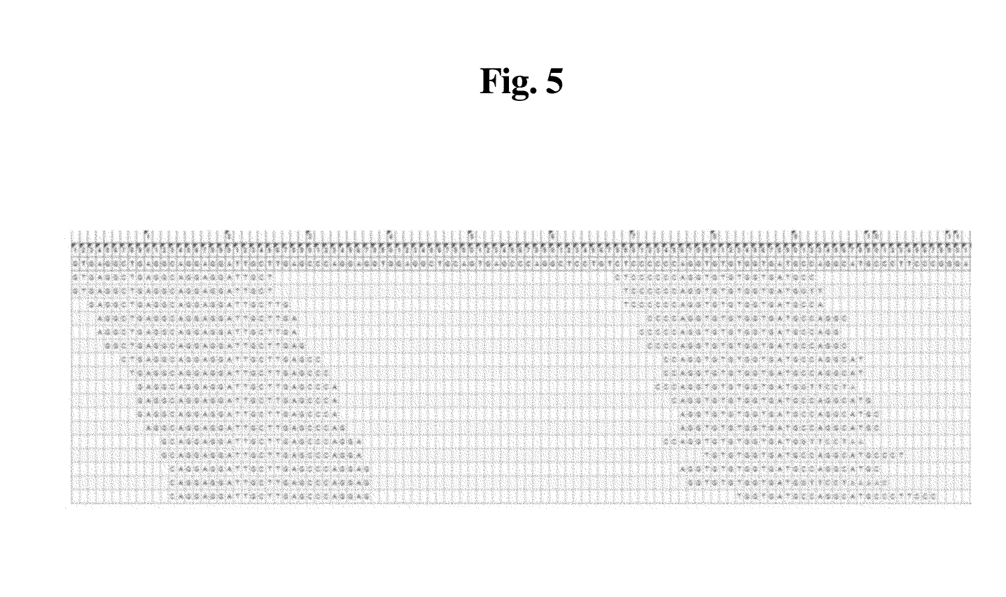

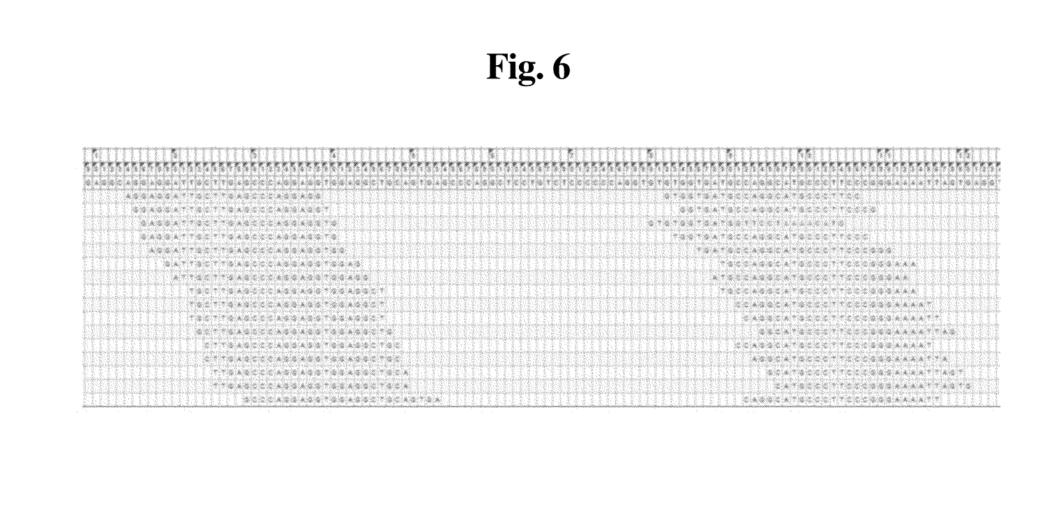

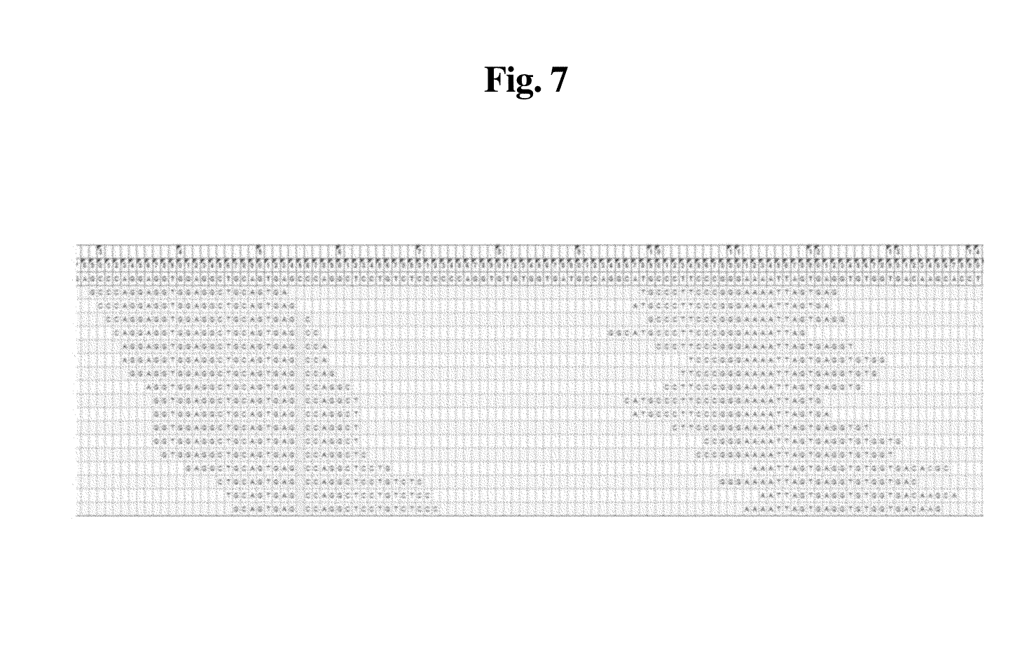

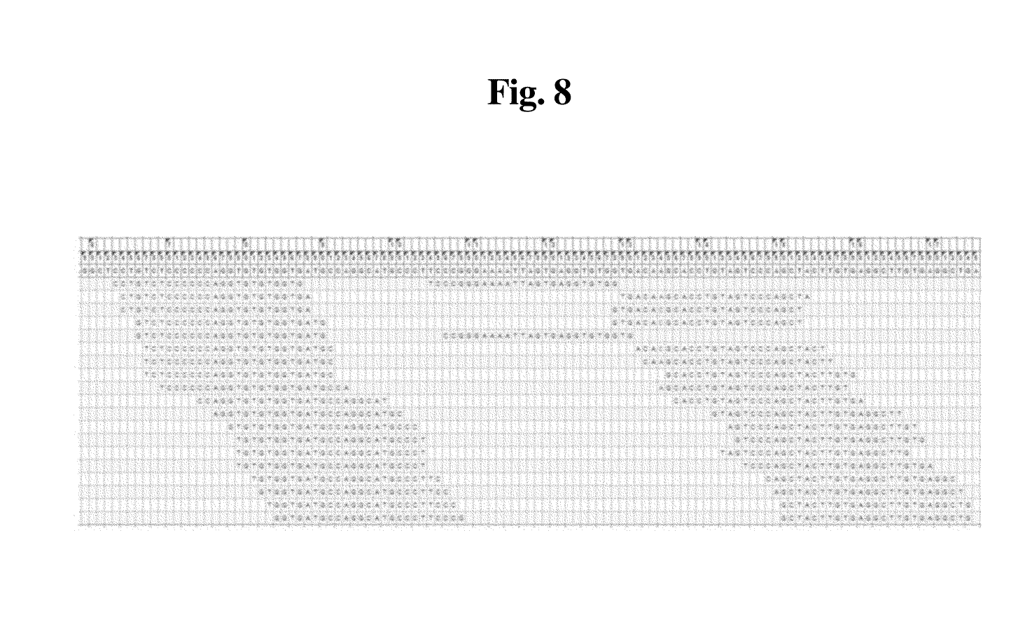

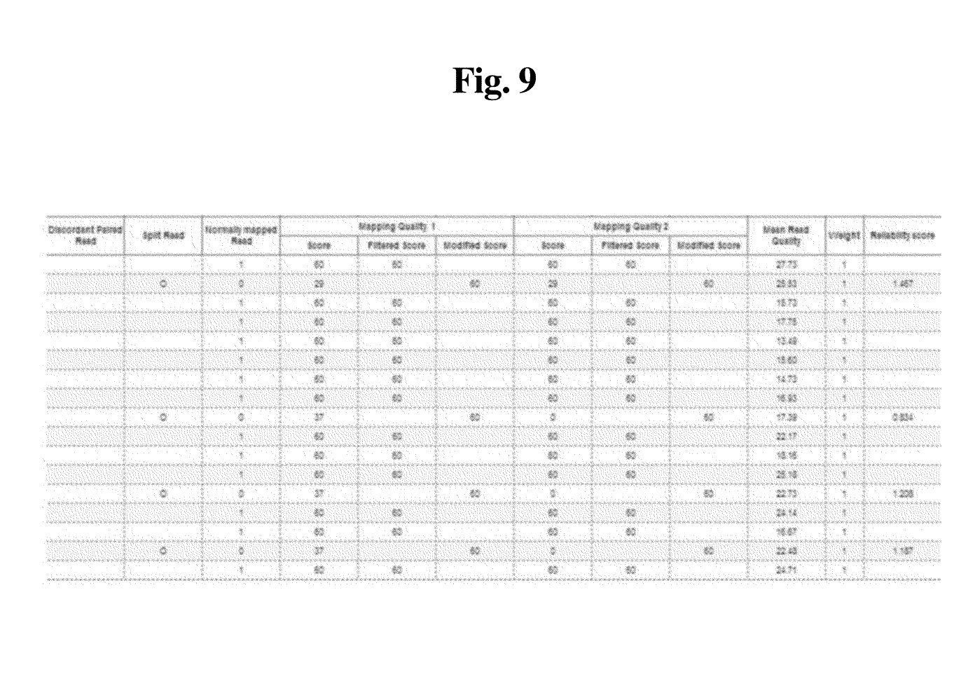

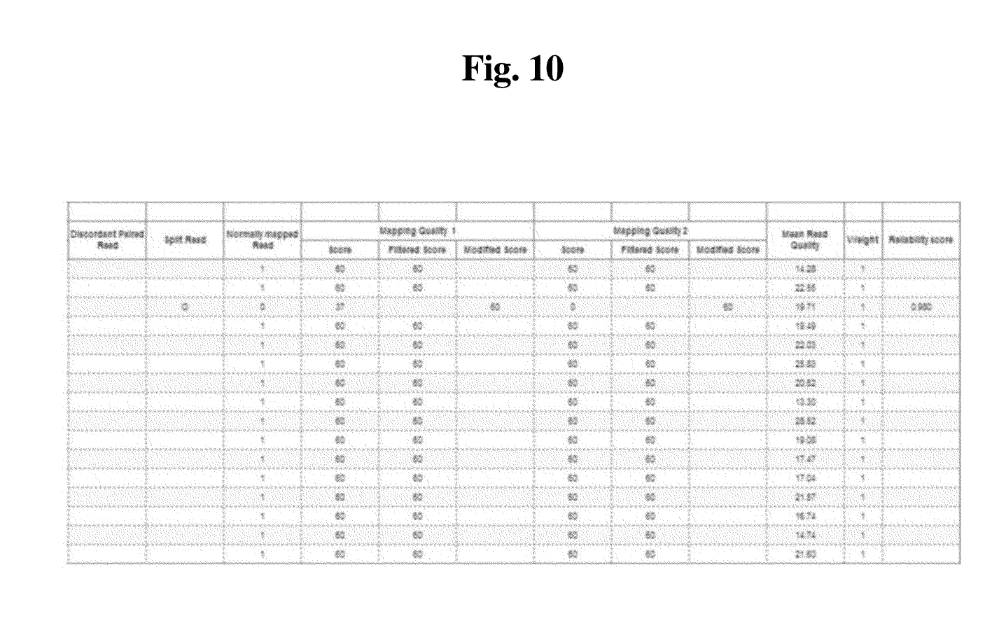

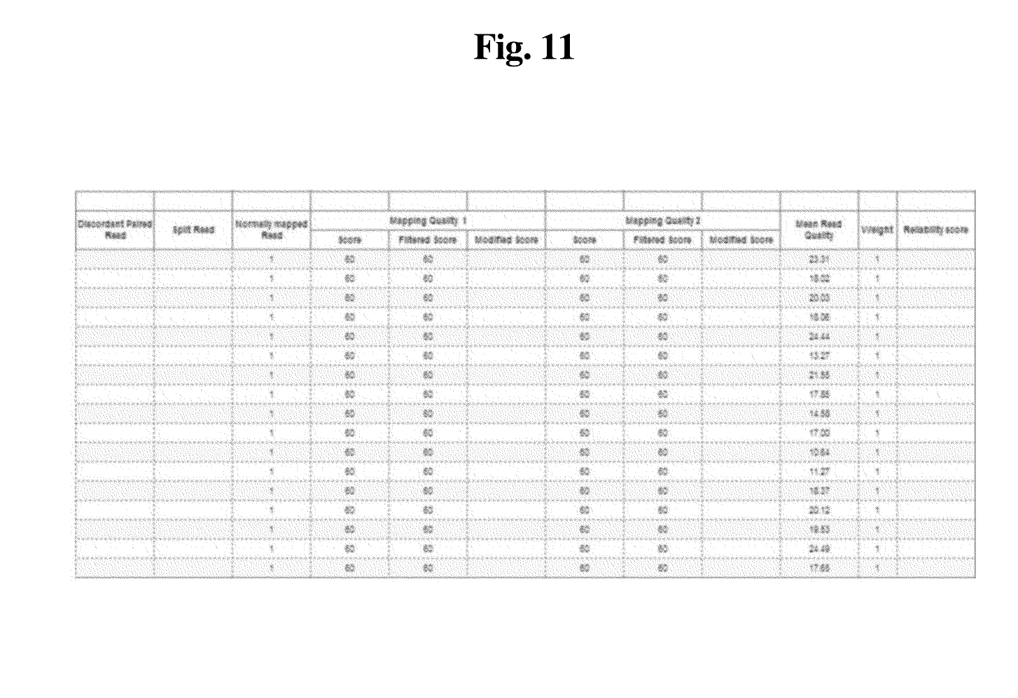

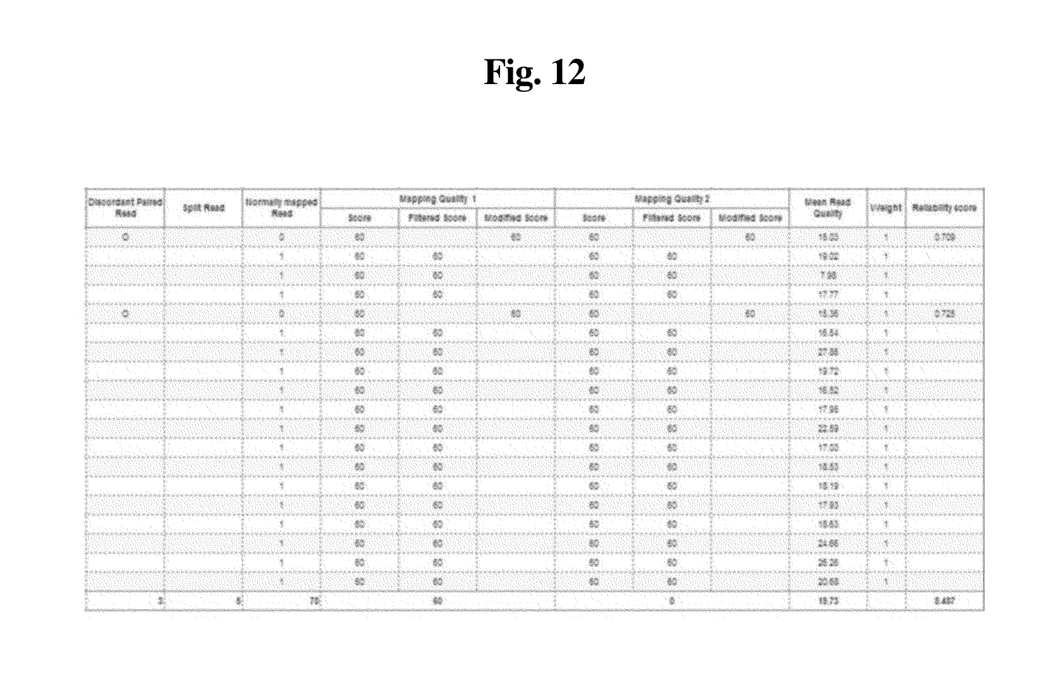

FIGS. 5-9 are exemplary sequences produced through simulations which are subjected to reliability calculations listed in Tables 1 and 2, and FIGS. 10-12 are the calculation results for each of said sequences of FIGS. 5-9. In the case of genetic variation 2 in FIGS. 5-9, it is located at intron. Thus, 0.5 point is given in the functional evaluation part per unit region. The association with breast cancer and ovarian cancer is reported and so one point is added to the score due to the association with diseases. The variation is located at a target region of a target anticancer agent, herceptin and so one point is added due to the association with the target anticancer agent. Therefore, the utility “U” according to the calculation formula resulted in a score of 2.5. In this regard, the genetic variation 2 of the three genetic variations is determined to be the highest.

In some embodiments of the present disclosure, the term “N masking” refers to a process for determining missing values for individual nucleotides of the sequence read at excessively low quality. The term “low quality read filtering” refers to a process for excluding values from the analysis of the sequence read in low quality(read).

In some embodiments of the present disclosure, the “global alignment” refers to a method of positioning the read entire sequence at the most similar portions of the reference sequences. The “local alignment” refers to a method of positioning some of the read sequences at the most similar portion of the reference sequences.

In some embodiments of the present disclosure, the genetic variation and the surrounding sequences of the samples are determined using the reads positioned near the genetic variation, and output files for the completed genetic variation sequence are prepared.

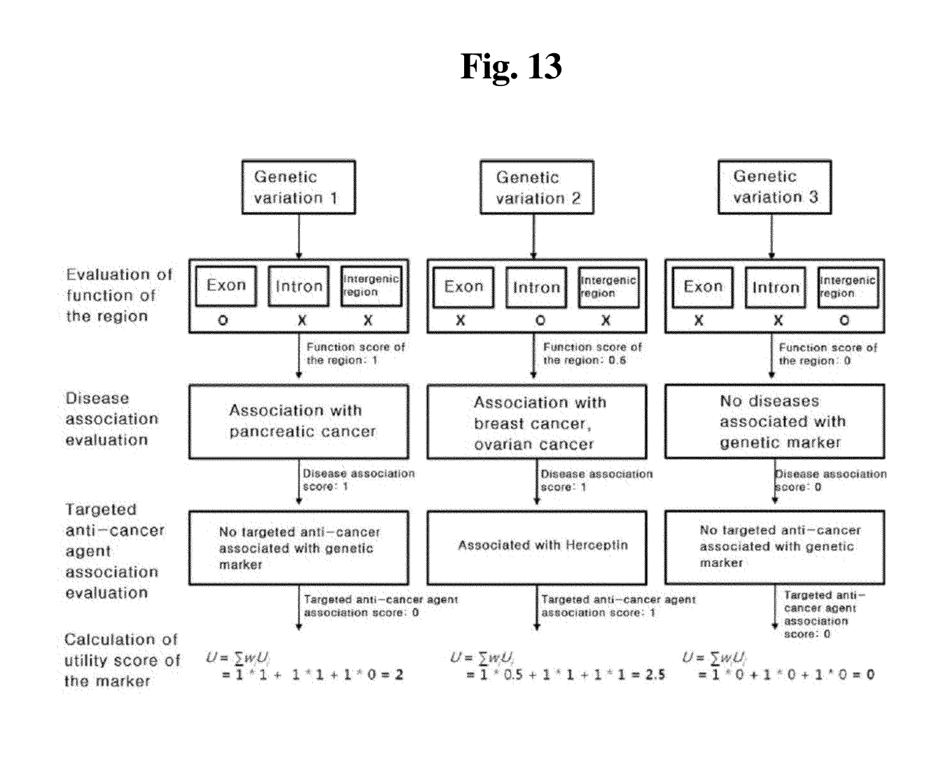

FIG. 13 is flowcharts of calculating utility scores of three genetic variations, on the basis of an association with biological traits of gene markers, in accordance with some embodiments of the present disclosure.

Since the genetic variation information extracted through the nucleotide sequence leads derived from the gene sequence analyzer include uncertainties, there are many cases in which identification processes using other analytical devices are required. Accordingly, through the method for providing information about gene sequence-based personal marker and the apparatus using same in accordance with the present disclosure, i) the personal genetic variation marker extraction is performed; ii) the extracted genetic variation marker is evaluated based on reliability, easiness and utility; and iii) the peripheral sequence information can be obtained at the same time, without using a separate program, so that it can be used for the identification experiment using the other analytical devices. In particular, in the case of cancer cell genes, it provides a genetic variation marker specific to the cancer cells and thus, it can be used as a tool for the detection of genes derived from cancer cells which are distinguished from genes derived from normal cells of a subject.

What is claimed is:

1. A method of providing information about a gene sequence-based personal marker, the method comprising:
obtaining base sequence-related information from a target sample;
performing a quality control of a base sequence corresponding to the base sequence-related information obtained from the target sample;
comparing the base sequence, for which the quality control is performed, with a reference sequence;
extracting a personal identification genetic variation marker from a result of the sequence comparison;
evaluating optimality of the extracted personal identification genetic variation marker; and
outputting a sequence corresponding to a personal identification genetic variation marker having the evaluated optimality which is higher than a predetermined level.

2. The method according to claim 1, wherein the evaluating the optimality comprises evaluating at least one selected from the group consisting of reliability, easiness, and utility, based on the obtained base sequence-related information.

3. The method according to claim 1, wherein the performing the quality control comprises at least one selected from the group consisting of trimming, N-masking and low quality read filtering, for each position of genes of a base sequence, based on the obtained base sequence-related information.

4. The method according to claim 1, wherein the comparing the sequences comprises comparing the sequences based on a global alignment or a local alignment.

5. The method according to claim 1, wherein the extracting the personal identification genetic variation marker comprises extracting a single-nucleotide polymorphism (SNP) or a structural variation (SV).

6. The method according to claim 2, wherein the reliability is evaluated by evaluating a statistical reliability from a number and composition of base sequence reads, based on the obtained base sequence-related information.

7. The method according to claim 2, wherein the easiness is evaluated by evaluating experimental ease based on analysis of an occurrence of repeated sequences, a GC content, and an extraction frequency of the personal identification genetic variation marker.

8. The method according to claim 2, wherein the utility is evaluated by evaluating biological utility concerning a degree of risk of diseases and an association with the diseases.

9. The method according to claim 2, wherein the outputting the sequence comprises outputting a peripheral sequence including a base sequence of genetic variations in a fasta format.

10. An apparatus for providing information about gene sequence-based personal marker, the apparatus comprising:
an input part configured to input base sequence-related information obtained from a target sample;
a quality control operation part configured to perform a quality control of a base sequence corresponding to the obtained base sequence-related information;
a comparison operation part configured to compare the base sequence, for which the quality control is performed, with a reference sequence;
a genetic variation extraction part configured to extract a personal identification genetic variation marker from the sequence comparison result;
a suitability operation part configured to evaluate optimality of the extracted personal identification genetic variation marker; and
an output part configured to output an evaluation result of the personal identification genetic variation marker optimality.

11. The apparatus according to claim 10, wherein the suitability operation part is configured to evaluate at least one selected from the group consisting of reliability, easiness, and utility, based on the obtained base sequence-related information.

12. The apparatus according to claim 10, wherein the quality control operation part is configured to perform at least one selected from the group consisting of trimming, N-masking and low quality read filtering, for each position of genes of a base sequence, based on the obtained base sequence-related information.

13. The apparatus according to claim 10, wherein the comparison operation part is configured to compare the sequences based on a global alignment or a local alignment.

14. The apparatus according to claim 10, wherein the genetic variation extraction part is configured to extract a single-nucleotide polymorphism (SNP) or a structural variation (SV).

15. The apparatus according to claim 10, wherein the suitability operation part is configured to evaluate the reliability by evaluating a statistical reliability from a number and composition of base sequence reads, based on the obtained base sequence-related information.

16. The apparatus according to claim 10, wherein the suitability operation part is configured to evaluate the easiness by evaluating experimental ease based on analysis of an occurrence of repeated sequences, a GC content, and an extraction frequency of the personal identification genetic variation marker.

17. The apparatus according to claim 10, wherein the suitability operation part is configured to evaluate the utility by evaluating biological utility concerning a degree of risk of diseases and an association with the diseases.

18. The apparatus according to claim 10, wherein the output part is configured to output a peripheral sequence including a base sequence of genetic variations in a fasta format.


SEQUENCE LISTING (146 sequences)

SEQ ID NO: 1 - DNA, 60 bp, Artificial Sequence
  Description of Artificial Sequence Synthetic oligonucleotide
gacgccccaggccgcggtggagttgcgcgcggcttcaaaagtggagtggagcaggcctgc

SEQ ID NO: 2 - DNA, 59 bp, Artificial Sequence
  Description of Artificial Sequence Synthetic oligonucleotide
agcacaggcaggcaccagctgggcagtgtwaggatgctggagcagcatccgtaccccac

SEQ ID NO: 3 - DNA, 60 bp, Artificial Sequence
  Description of Artificial Sequence Synthetic oligonucleotide
gggcgcgggcgcgcggggcggcggtgagggcggctggcggggccgggggcgccggggggg

SEQ ID NO: 4 - DNA, 60 bp, Artificial Sequence
  Description of Artificial Sequence Synthetic oligonucleotide
ccactggggagaggctgttctgactctgcaggtgggacagggacagatggccaccagggt

SEQ ID NO: 5 - DNA, 111 bp, Artificial Sequence
  Description of Artificial Sequence Synthetic polynucleotide
gtgaggctgaggcaggaggattgcttgagcccaggaggtggaggctgcagtgagcccaggctcctgtctccccccaggtgtgtggtgatgccaggcatgcccttcccggga

SEQ ID NO: 6 - DNA, 25 bp, Artificial Sequence
  Description of Artificial Sequence Synthetic oligonucleotide
gtgaggctgaggcaggaggattgct

SEQ ID NO: 7 - DNA, 25 bp, Artificial Sequence
  Description of Artificial Sequence Synthetic oligonucleotide
ctccccccaggtgtgtggtgatgcc

SEQ ID NO: 8 - DNA, 25 bp, Artificial Sequence
  Description of Artificial Sequence Synthetic oligonucleotide
gtgaggctgaggcaggaggattgct

SEQ ID NO: 9 - DNA, 25 bp, Artificial Sequence
  Description of Artificial Sequence Synthetic oligonucleotide
tccccccaggtgtgtggtgatggtt

SEQ ID NO: 10 - DNA, 25 bp, Artificial Sequence
  Description of Artificial Sequence Synthetic oligonucleotide
gaggctgaggcaggaggattgcttg

SEQ ID NO: 11 - DNA, 25 bp, Artificial Sequence
  Description of Artificial Sequence Synthetic oligonucleotide
tccccccaggtgtgtggtgatgcca

SEQ ID NO: 12 - DNA, 25 bp, Artificial Sequence
  Description of Artificial Sequence Synthetic oligonucleotide
aggctgaggcaggaggattgcttga

SEQ ID NO: 13 - DNA, 25 bp, Artificial Sequence
  Description of Artificial Sequence Synthetic oligonucleotide
ccccaggtgtgtggtgatgccaggc

SEQ ID NO: 14 - DNA, 25 bp, Artificial Sequence
  Description of Artificial Sequence Synthetic oligonucleotide
aggctgaggcaggaggattgcttga

SEQ ID NO: 15 - DNA, 25 bp, Artificial Sequence
  Description of Artificial Sequence Synthetic oligonucleotide
cccccaggtgtgtggtgatgccagg

SEQ ID NO: 16 - DNA, 25 bp, Artificial Sequence
  Description of Artificial Sequence Synthetic oligonucleotide
ggctgaggcaggaggattgcttgag

SEQ ID NO: 17 - DNA, 25 bp, Artificial Sequence
  Description of Artificial Sequence Synthetic oligonucleotide
ccccaggtgtgtggtgatgccaggc

SEQ ID NO: 18 - DNA, 25 bp, Artificial Sequence
  Description of Artificial Sequence Synthetic oligonucleotide
ctgaggcaggaggattgcttgagcc

SEQ ID NO: 19 - DNA, 25 bp, Artificial Sequence
  Description of Artificial Sequence Synthetic oligonucleotide
ccaggtgtgtggtgatgccaggcat

SEQ ID NO: 20 - DNA, 25 bp, Artificial Sequence
  Description of Artificial Sequence Synthetic oligonucleotide
tgaggcaggaggattgcttgagccc

SEQ ID NO: 21 - DNA, 25 bp, Artificial Sequence
  Description of Artificial Sequence Synthetic oligonucleotide
ccaggtgtgtggtgatgccaggcat

SEQ ID NO: 22 - DNA, 25 bp, Artificial Sequence
  Description of Artificial Sequence Synthetic oligonucleotide
gaggcaggaggattgcttgagccca

SEQ ID NO: 23 - DNA, 25 bp, Artificial Sequence
  Description of Artificial Sequence Synthetic oligonucleotide
cccaggtgtgtggtgatggttccta

SEQ ID NO: 24 - DNA, 25 bp, Artificial Sequence
  Description of Artificial Sequence Synthetic oligonucleotide
gaggcaggaggattgcttgagccca

SEQ ID NO: 25 - DNA, 25 bp, Artificial Sequence
  Description of Artificial Sequence Synthetic oligonucleotide
caggtgtgtggtgatgccaggcatg

SEQ ID NO: 26 - DNA, 25 bp, Artificial Sequence
  Description of Artificial Sequence Synthetic oligonucleotide
gaggcaggaggattgcttgagccca

SEQ ID NO: 27 - DNA, 25 bp, Artificial Sequence
  Description of Artificial Sequence Synthetic oligonucleotide
aggtgtgtggtgatgccaggcatgc

SEQ ID NO: 28 - DNA, 25 bp, Artificial Sequence
  Description of Artificial Sequence Synthetic oligonucleotide
aggcaggaggattgcttgagcccag

SEQ ID NO: 29 - DNA, 25 bp, Artificial Sequence
  Description of Artificial Sequence Synthetic oligonucleotide
aggtgtgtggtgatgccaggcatgc

SEQ ID NO: 30 - DNA, 25 bp, Artificial Sequence
  Description of Artificial Sequence Synthetic oligonucleotide
gcaggaggattgcttgagcccagga

SEQ ID NO: 31 - DNA, 25 bp, Artificial Sequence
  Description of Artificial Sequence Synthetic oligonucleotide
ccaggtgtgtggtgatggttcctaa

SEQ ID NO: 32 - DNA, 25 bp, Artificial Sequence
  Description of Artificial Sequence Synthetic oligonucleotide
gcaggaggattgcttgagcccagga

SEQ ID NO: 33 - DNA, 25 bp, Artificial Sequence
  Description of Artificial Sequence Synthetic oligonucleotide
tgtgtggtgatgccaggcatgccct

SEQ ID NO: 34 - DNA, 25 bp, Artificial Sequence
  Description of Artificial Sequence Synthetic oligonucleotide
caggaggattgcttgagcccaggag

SEQ ID NO: 35 - DNA, 25 bp, Artificial Sequence
  Description of Artificial Sequence Synthetic oligonucleotide
aggtgtgtggtgatgccaggcatgc

SEQ ID NO: 36 - DNA, 25 bp, Artificial Sequence
  Description of Artificial Sequence Synthetic oligonucleotide
caggaggattgcttgagcccaggag

SEQ ID NO: 37 - DNA, 25 bp, Artificial Sequence
  Description of Artificial Sequence Synthetic oligonucleotide
ggtgtgtggtgatggttcctaaaac

SEQ ID NO: 38 - DNA, 25 bp, Artificial Sequence
  Description of Artificial Sequence Synthetic oligonucleotide
caggaggattgcttgagcccaggag

SEQ ID NO: 39 - DNA, 25 bp, Artificial Sequence
  Description of Artificial Sequence Synthetic oligonucleotide
tggtgatgccaggcatgcccttccc

SEQ ID NO: 40 - DNA, 115 bp, Artificial Sequence
  Description of Artificial Sequence Synthetic polynucleotide
gaggcaggaggattgcttgagcccaggaggtggaggctgcagtgagcccaggctcctgtctccccccaggtgtgtggtgatgccaggcatgcccttcccgggaaaattagtgagg

SEQ ID NO: 41 - DNA, 25 bp, Artificial Sequence
  Description of Artificial Sequence Synthetic oligonucleotide
aggaggattgcttgagcccaggagg

SEQ ID NO: 42 - DNA, 25 bp, Artificial Sequence
  Description of Artificial Sequence Synthetic oligonucleotide
gtggtgatgccaggcatgcccttcc

SEQ ID NO: 43 - DNA, 25 bp, Artificial Sequence
  Description of Artificial Sequence Synthetic oligonucleotide
ggaggattgcttgagcccaggaggt

SEQ ID NO: 44 - DNA, 25 bp, Artificial Sequence
  Description of Artificial Sequence Synthetic oligonucleotide
ggtgatgccaggcatgcccttcccg

SEQ ID NO: 45 - DNA, 25 bp, Artificial Sequence
  Description of Artificial Sequence Synthetic oligonucleotide
gaggattgcttgagcccaggaggtg

SEQ ID NO: 46 - DNA, 25 bp, Artificial Sequence
  Description of Artificial Sequence Synthetic oligonucleotide
gtgtggtgatggttcctaaaacatg

SEQ ID NO: 47 - DNA, 25 bp, Artificial Sequence
  Description of Artificial Sequence Synthetic oligonucleotide
gaggattgcttgagcccaggaggtg

SEQ ID NO: 48 - DNA, 25 bp, Artificial Sequence
  Description of Artificial Sequence Synthetic oligonucleotide
tggtgatgccaggcatgcccttccc

SEQ ID NO: 49 - DNA, 25 bp, Artificial Sequence
  Description of Artificial Sequence Synthetic oligonucleotide
aggattgcttgagcccaggaggtgg

SEQ ID NO: 50 - DNA, 25 bp, Artificial Sequence
  Description of Artificial Sequence Synthetic oligonucleotide
tgatgccaggcatgcccttcccggg

SEQ ID NO: 51 - DNA, 25 bp, Artificial Sequence
  Description of Artificial Sequence Synthetic oligonucleotide
gattgcttgagcccaggaggtggag

SEQ ID NO: 52 - DNA, 25 bp, Artificial Sequence
  Description of Artificial Sequence Synthetic oligonucleotide
tgccaggcatgcccttcccgggaaa

SEQ ID NO: 53 - DNA, 25 bp, Artificial Sequence
  Description of Artificial Sequence Synthetic oligonucleotide
attgcttgagcccaggaggtggagg

SEQ ID NO: 54 - DNA, 25 bp, Artificial Sequence
  Description of Artificial Sequence Synthetic oligonucleotide
atgccaggcatgcccttcccgggaa

SEQ ID NO: 55 - DNA, 25 bp, Artificial Sequence
  Description of Artificial Sequence Synthetic oligonucleotide
tgcttgagcccaggaggtggaggct

SEQ ID NO: 56 - DNA, 25 bp, Artificial Sequence
  Description of Artificial Sequence Synthetic oligonucleotide
tgccaggcatgcccttcccgggaaa

SEQ ID NO: 57 - DNA, 25 bp, Artificial Sequence
  Description of Artificial Sequence Synthetic oligonucleotide
tgcttgagcccaggaggtggaggct

SEQ ID NO: 58 - DNA, 25 bp, Artificial Sequence
  Description of Artificial Sequence Synthetic oligonucleotide
ccaggcatgcccttcccgggaaaat

SEQ ID NO: 59 - DNA, 25 bp, Artificial Sequence
  Description of Artificial Sequence Synthetic oligonucleotide
tgcttgagcccaggaggtggaggct

SEQ ID NO: 60 - DNA, 25 bp, Artificial Sequence
  Description of Artificial Sequence Synthetic oligonucleotide
caggcatgcccttcccgggaaaatt

SEQ ID NO: 61 - DNA, 25 bp, Artificial Sequence
  Description of Artificial Sequence Synthetic oligonucleotide
gcttgagcccaggaggtggaggctg

SEQ ID NO: 62 - DNA, 25 bp, Artificial Sequence
  Description of Artificial Sequence Synthetic oligonucleotide
ggcatgcccttcccgggaaaattag

SEQ ID NO: 63 - DNA, 25 bp, Artificial Sequence
  Description of Artificial Sequence Synthetic oligonucleotide
cttgagcccaggaggtggaggctgc

SEQ ID NO: 64 - DNA, 25 bp, Artificial Sequence
  Description of Artificial Sequence Synthetic oligonucleotide
ccaggcatgcccttcccgggaaaat

SEQ ID NO: 65 - DNA, 25 bp, Artificial Sequence
  Description of Artificial Sequence Synthetic oligonucleotide
cttgagcccaggaggtggaggctgc

SEQ ID NO: 66 - DNA, 25 bp, Artificial Sequence
  Description of Artificial Sequence Synthetic oligonucleotide
aggcatgcccttcccgggaaaatta

SEQ ID NO: 67 - DNA, 25 bp, Artificial Sequence
  Description of Artificial Sequence Synthetic oligonucleotide
ttgagcccaggaggtggaggctgca

SEQ ID NO: 68 - DNA, 25 bp, Artificial Sequence
  Description of Artificial Sequence Synthetic oligonucleotide
gcatgcccttcccgggaaaattagt

SEQ ID NO: 69 - DNA, 25 bp, Artificial Sequence
  Description of Artificial Sequence Synthetic oligonucleotide
ttgagcccaggaggtggaggctgca

SEQ ID NO: 70 - DNA, 25 bp, Artificial Sequence
  Description of Artificial Sequence Synthetic oligonucleotide
catgcccttcccgggaaaattagtg

SEQ ID NO: 71 - DNA, 25 bp, Artificial Sequence
  Description of Artificial Sequence Synthetic oligonucleotide
gcccaggaggtggaggctgcagtga

SEQ ID NO: 72 - DNA, 25 bp, Artificial Sequence
  Description of Artificial Sequence Synthetic oligonucleotide
caggcatgcccttcccgggaaaatt

SEQ ID NO: 73 - DNA, 114 bp, Artificial Sequence
  Description of Artificial Sequence Synthetic polynucleotide
gagcccaggaggtggaggctgcagtgagcccaggctcctgtctccccccaggtgtgtggtgatgccaggcatgcccttcccgggaaaattagtgaggtgtggtgacaagcacct

SEQ ID NO: 74 - DNA, 25 bp, Artificial Sequence
  Description of Artificial Sequence Synthetic oligonucleotide
gcccaggaggtggaggctgcagtga

SEQ ID NO: 75 - DNA, 25 bp, Artificial Sequence
  Description of Artificial Sequence Synthetic oligonucleotide
tgcccttcccgggaaaattagtgag

SEQ ID NO: 76 - DNA, 25 bp, Artificial Sequence
  Description of Artificial Sequence Synthetic oligonucleotide
cccaggaggtggaggctgcagtgag

SEQ ID NO: 77 - DNA, 25 bp, Artificial Sequence
  Description of Artificial Sequence Synthetic oligonucleotide
atgcccttcccgggaaaattagtga

SEQ ID NO: 78 - DNA, 25 bp, Artificial Sequence
  Description of Artificial Sequence Synthetic oligonucleotide
ccaggaggtggaggctgcagtgagc

SEQ ID NO: 79 - DNA, 25 bp, Artificial Sequence
  Description of Artificial Sequence Synthetic oligonucleotide
gcccttcccgggaaaattagtgagg

SEQ ID NO: 80 - DNA, 25 bp, Artificial Sequence
  Description of Artificial Sequence Synthetic oligonucleotide
caggaggtggaggctgcagtgagcc

SEQ ID NO: 81 - DNA, 25 bp, Artificial Sequence
  Description of Artificial Sequence Synthetic oligonucleotide
ggcatgcccttcccgggaaaattag

SEQ ID NO: 82 - DNA, 25 bp, Artificial Sequence
  Description of Artificial Sequence Synthetic oligonucleotide
aggaggtggaggctgcagtgagcca

SEQ ID NO: 83 - DNA, 25 bp, Artificial Sequence
  Description of Artificial Sequence Synthetic oligonucleotide
cccttcccgggaaaattagtgaggt

SEQ ID NO: 84 - DNA, 25 bp, Artificial Sequence
  Description of Artificial Sequence Synthetic oligonucleotide
aggaggtggaggctgcagtgagcca

SEQ ID NO: 85 - DNA, 25 bp, Artificial Sequence
  Description of Artificial Sequence Synthetic oligonucleotide
tcccgggaaaattagtgaggtgtgg

SEQ ID NO: 86 - DNA, 25 bp, Artificial Sequence
  Description of Artificial Sequence Synthetic oligonucleotide
ggaggtggaggctgcagtgagccag

SEQ ID NO: 87 - DNA, 25 bp, Artificial Sequence
  Description of Artificial Sequence Synthetic oligonucleotide
ttcccgggaaaattagtgaggtgtg

SEQ ID NO: 88 - DNA, 25 bp, Artificial Sequence
  Description of Artificial Sequence Synthetic oligonucleotide
aggtggaggctgcagtgagccaggc

SEQ ID NO: 89 - DNA, 25 bp, Artificial Sequence
  Description of Artificial Sequence Synthetic oligonucleotide
ccttcccgggaaaattagtgaggtg

SEQ ID NO: 90 - DNA, 25 bp, Artificial Sequence
  Description of Artificial Sequence Synthetic oligonucleotide
ggtggaggctgcagtgagccaggct

SEQ ID NO: 91 - DNA, 25 bp, Artificial Sequence
  Description of Artificial Sequence Synthetic oligonucleotide
catgcccttcccgggaaaattagtg

SEQ ID NO: 92 - DNA, 25 bp, Artificial Sequence
  Description of Artificial Sequence Synthetic oligonucleotide
ggtggaggctgcagtgagccaggct

SEQ ID NO: 93 - DNA, 25 bp, Artificial Sequence
  Description of Artificial Sequence Synthetic oligonucleotide
atgcccttcccgggaaaattagtga

SEQ ID NO: 94 - DNA, 25 bp, Artificial Sequence
  Description of Artificial Sequence Synthetic oligonucleotide
ggtggaggctgcagtgagccaggct

SEQ ID NO: 95 - DNA, 25 bp, Artificial Sequence
  Description of Artificial Sequence Synthetic oligonucleotide
cttcccgggaaaattagtgaggtgt

SEQ ID NO: 96 - DNA, 25 bp, Artificial Sequence
  Description of Artificial Sequence Synthetic oligonucleotide
ggtggaggctgcagtgagccaggct

SEQ ID NO: 97 - DNA, 25 bp, Artificial Sequence
  Description of Artificial Sequence Synthetic oligonucleotide
ccgggaaaattagtgaggtgtggtg

SEQ ID NO: 98 - DNA, 25 bp, Artificial Sequence
  Description of Artificial Sequence Synthetic oligonucleotide
gtggaggctgcagtgagccaggctc

SEQ ID NO: 99 - DNA, 25 bp, Artificial Sequence
  Description of Artificial Sequence Synthetic oligonucleotide
cccgggaaaattagtgaggtgtggt

SEQ ID NO: 100 - DNA, 25 bp, Artificial Sequence
  Description of Artificial Sequence Synthetic oligonucleotide
gaggctgcagtgagccaggctcctg

SEQ ID NO: 101 - DNA, 25 bp, Artificial Sequence
  Description of Artificial Sequence Synthetic oligonucleotide
aaattagtgaggtgtggtgacacgc

SEQ ID NO: 102 - DNA, 25 bp, Artificial Sequence
  Description of Artificial Sequence Synthetic oligonucleotide
ctgcagtgagccaggctcctgtctc

SEQ ID NO: 103 - DNA, 25 bp, Artificial Sequence
  Description of Artificial Sequence Synthetic oligonucleotide
gggaaaattagtgaggtgtggtgac

SEQ ID NO: 104 - DNA, 25 bp, Artificial Sequence
  Description of Artificial Sequence Synthetic oligonucleotide
tgcagtgagccaggctcctgtctcc

SEQ ID NO: 105 - DNA, 25 bp, Artificial Sequence
  Description of Artificial Sequence Synthetic oligonucleotide
aattagtgaggtgtggtgacaagca

SEQ ID NO: 106 - DNA, 25 bp, Artificial Sequence
  Description of Artificial Sequence Synthetic oligonucleotide
gcagtgagccaggctcctgtctccc

SEQ ID NO: 107 - DNA, 25 bp, Artificial Sequence
  Description of Artificial Sequence Synthetic oligonucleotide
aaaattagtgaggtgtggtgacaag

SEQ ID NO: 108 - DNA, 117 bp, Artificial Sequence
  Description of Artificial Sequence Synthetic polynucleotide
ggctcctgtctccccccaggtgtgtggtgatgccaggcatgcccttcccgggaaaattagtgaggtgtggtgacaagcacctgtagtcccagctacttgtgaggcttgtgaggctga

SEQ ID NO: 109 - DNA, 25 bp, Artificial Sequence
  Description of Artificial Sequence Synthetic oligonucleotide
cctgtctccccccaggtgtgtggtg

SEQ ID NO: 110 - DNA, 25 bp, Artificial Sequence
  Description of Artificial Sequence Synthetic oligonucleotide
tcccgggaaaattagtgaggtgtgg

SEQ ID NO: 111 - DNA, 25 bp, Artificial Sequence
  Description of Artificial Sequence Synthetic oligonucleotide
ctgtctccccccaggtgtgtggtga

SEQ ID NO: 112 - DNA, 25 bp, Artificial Sequence
  Description of Artificial Sequence Synthetic oligonucleotide
tgacaagcacctgtagtcccagcta

SEQ ID NO: 113 - DNA, 25 bp, Artificial Sequence
  Description of Artificial Sequence Synthetic oligonucleotide
ctgtctccccccaggtgtgtggtga

SEQ ID NO: 114 - DNA, 25 bp, Artificial Sequence
  Description of Artificial Sequence Synthetic oligonucleotide
gtgacacgcacctgtagtcccagct

SEQ ID NO: 115 - DNA, 25 bp, Artificial Sequence
  Description of Artificial Sequence Synthetic oligonucleotide
gtctccccccaggtgtgtggtgatg

SEQ ID NO: 116 - DNA, 25 bp, Artificial Sequence
  Description of Artificial Sequence Synthetic oligonucleotide
gtgacacgcacctgtagtcccagct

SEQ ID NO: 117 - DNA, 25 bp, Artificial Sequence
  Description of Artificial Sequence Synthetic oligonucleotide
gtctccccccaggtgtgtggtgatg

SEQ ID NO: 118 - DNA, 25 bp, Artificial Sequence
  Description of Artificial Sequence Synthetic oligonucleotide
ccgggaaaattagtgaggtgtggtg

SEQ ID NO: 119 - DNA, 25 bp, Artificial Sequence
  Description of Artificial Sequence Synthetic oligonucleotide
tctccccccaggtgtgtggtgatgc

SEQ ID NO: 120 - DNA, 25 bp, Artificial Sequence
  Description of Artificial Sequence Synthetic oligonucleotide
acacgcacctgtagtcccagctact

SEQ ID NO: 121 - DNA, 25 bp, Artificial Sequence
  Description of Artificial Sequence Synthetic oligonucleotide
tctccccccaggtgtgtggtgatgc

SEQ ID NO: 122 - DNA, 25 bp, Artificial Sequence
  Description of Artificial Sequence Synthetic oligonucleotide
caagcacctgtagtcccagctactt

SEQ ID NO: 123 - DNA, 25 bp, Artificial Sequence
  Description of Artificial Sequence Synthetic oligonucleotide
tctccccccaggtgtgtggtgatgc

SEQ ID NO: 124 - DNA, 25 bp, Artificial Sequence
  Description of Artificial Sequence Synthetic oligonucleotide
gcacctgtagtcccagctacttgtg

SEQ ID NO: 125 - DNA, 25 bp, Artificial Sequence
  Description of Artificial Sequence Synthetic oligonucleotide
tccccccaggtgtgtggtgatgcca

SEQ ID NO: 126 - DNA, 25 bp, Artificial Sequence
  Description of Artificial Sequence Synthetic oligonucleotide
agcacctgtagtcccagctacttgt

SEQ ID NO: 127 - DNA, 25 bp, Artificial Sequence
  Description of Artificial Sequence Synthetic oligonucleotide
ccaggtgtgtggtgatgccaggcat

SEQ ID NO: 128 - DNA, 25 bp, Artificial Sequence
  Description of Artificial Sequence Synthetic oligonucleotide
cacctgtagtcccagctacttgtga

SEQ ID NO: 129 - DNA, 25 bp, Artificial Sequence
  Description of Artificial Sequence Synthetic oligonucleotide
aggtgtgtggtgatgccaggcatgc

SEQ ID NO: 130 - DNA, 25 bp, Artificial Sequence
  Description of Artificial Sequence Synthetic oligonucleotide
gtagtcccagctacttgtgaggctt

SEQ ID NO: 131 - DNA, 25 bp, Artificial Sequence
  Description of Artificial Sequence Synthetic oligonucleotide
gtgtgtggtgatgccaggcatgccc

SEQ ID NO: 132 - DNA, 25 bp, Artificial Sequence
  Description of Artificial Sequence Synthetic oligonucleotide
agtcccagctacttgtgaggcttgt

SEQ ID NO: 133 - DNA, 25 bp, Artificial Sequence
  Description of Artificial Sequence Synthetic oligonucleotide
tgtgtggtgatgccaggcatgccct

SEQ ID NO: 134 - DNA, 25 bp, Artificial Sequence
  Description of Artificial Sequence Synthetic oligonucleotide
gtcccagctacttgtgaggcttgtg

SEQ ID NO: 135 - DNA, 25 bp, Artificial Sequence
  Description of Artificial Sequence Synthetic oligonucleotide
tgtgtggtgatgccaggcatgccct

SEQ ID NO: 136 - DNA, 25 bp, Artificial Sequence
  Description of Artificial Sequence Synthetic oligonucleotide
tagtcccagctacttgtgaggcttg

SEQ ID NO: 137 - DNA, 25 bp, Artificial Sequence
  Description of Artificial Sequence Synthetic oligonucleotide
tgtgtggtgatgccaggcatgccct

SEQ ID NO: 138 - DNA, 25 bp, Artificial Sequence
  Description of Artificial Sequence Synthetic oligonucleotide
tcccagctacttgtgaggcttgtga

SEQ ID NO: 139 - DNA, 25 bp, Artificial Sequence
  Description of Artificial Sequence Synthetic oligonucleotide
tgtggtgatgccaggcatgcccttc

SEQ ID NO: 140 - DNA, 25 bp, Artificial Sequence
  Description of Artificial Sequence Synthetic oligonucleotide
cagctacttgtgaggcttgtgaggc

SEQ ID NO: 141 - DNA, 25 bp, Artificial Sequence
  Description of Artificial Sequence Synthetic oligonucleotide
gtggtgatgccaggcatgcccttcc

SEQ ID NO: 142 - DNA, 25 bp, Artificial Sequence
  Description of Artificial Sequence Synthetic oligonucleotide
agctacttgtgaggcttgtgaggct

SEQ ID NO: 143 - DNA, 25 bp, Artificial Sequence
  Description of Artificial Sequence Synthetic oligonucleotide
tggtgatgccaggcatgcccttccc

SEQ ID NO: 144 - DNA, 25 bp, Artificial Sequence
  Description of Artificial Sequence Synthetic oligonucleotide
gctacttgtgaggcttgtgaggctg

SEQ ID NO: 145 - DNA, 25 bp, Artificial Sequence
  Description of Artificial Sequence Synthetic oligonucleotide
ggtgatgccaggcatgcccttcccg

SEQ ID NO: 146 - DNA, 25 bp, Artificial Sequence
  Description of Artificial Sequence Synthetic oligonucleotide
gctacttgtgaggcttgtgaggctg